(19) United States
(12) Patent Application Publication
(10) Pub. No.: US 2014/0229374 A1
(43) Pub. Date: Aug. 14, 2014

(54) HANDHELD ELECTRONIC BANKING DEVICE

(71) Applicant: LaToya H. James, Euharlee, GA (US)

(72) Inventor: LaToya H. James, Euharlee, GA (US)

(21) Appl. No.: 13/767,000

(22) Filed: Feb. 14, 2013

(51) Int. Cl. G06Q 20/10

(52) U.S. Cl. CPC G06Q 20/108
USPC 705/42

(57) ABSTRACT

A mobile, handheld electronic (processor-based) device that can be used for banking functions, including writing checks from a checking account, confirming the account balance, reviewing account activity in a ledger format, and other banking-related functions. Using the processor, the device may: (a) maintain and display both a ledger for the personal bank checking account and a current account dollar balance for the personal bank checking account based on the check data and the deposit data stored in the at least one memory; (b) transmit, via a local data network, data for a new check written by the user from the personal bank checking account at a point-of-sale location; and (c) update activity for the checking account with transaction data received from a remote bank computer server system via the mobile telecommunications network.

### BACKGROUND

Mobile banking is a term that connotes the use of mobile devices for financial services. Until recently, most mobile banking services have been provided using Short Message Service (SMS), a text messaging service. In such SMS-based services, a banking customer might receive a text message about activity on their checking account, such as an overdraft. The recent advent of more sophisticated smartphones has led to increasing use of special client programs, called “apps,” that can be downloaded to mobile devices and that provide more sophisticated mobile banking services, such as those that a bank customer can access through a bank web site.

### SUMMARY

In one general aspect, the present invention is directed to a mobile, handheld electronic (processor-based) device that can be used for banking functions, including writing checks from a checking account, confirming the account balance, reviewing account activity in a ledger format, and other banking-related functions. In various embodiments, the device comprises: a touch screen interface; at least one memory unit; at least one processor; a mobile telecommunications transceiver; and a local network transceiver. The memory unit stores bank account data for a personal checking account of the user at a bank, such as: a routing number for the bank associated with the user's personal bank checking account; an account number for the user's personal bank checking account; check data that comprises, for each check written from the personal bank checking account over the time period, (i) a check dollar amount, (ii) a date, and (iii) a payee; and deposit data that comprises, for each deposit to the personal bank checking account over the time period, (i) a deposit dollar amount, and (ii) a date. The mobile telecommunications transceiver is in communication with the at least one processor, and is for sending and receiving wireless communications via a mobile telecommunications network. The local network transceiver is also in communication with the at least one processor, and it is for sending and receiving wireless communications via a local data network.

The at least one processor may be programmed to: (a) maintain and display both a ledger for the personal bank checking account of the user that is displayable on the touch screen interface upon a request from the user, and a current account dollar balance for the personal bank checking account based on the check data and the deposit data stored in the at least one memory; (b) transmit, via the local data network, data for a new check written by the user from the personal bank checking account at a point-of-sale location when a point-of-sale check request is initiated by the user via the touch screen interface, wherein the transmitted data for the new check comprises (i) the routing number for the for the bank associated with the user's personal bank checking account, (ii) the account number for the user's personal bank checking account, and (iii) the check dollar amount, and wherein the routing number and the account number are not displayed on the touch screen interface when the user inputs data via the touch screen interface to issue the new check from the user's personal bank checking account; and (c) update activity for the checking account with transaction data received from a remote bank computer server system via the mobile telecommunications network, wherein the remote bank computer server system stores account data of the bank for the personal bank checking account of the user, to update the check and deposit data stored in the at least one memory of the device with the account data for the personal bank checking account of the user stored at the remote bank computer server system.

These and various features of the present invention to be apparent from the description below.

### FIGURES

Various embodiments of the present invention are described herein by way of example in conjunction with the following figures, wherein:

FIGS. 1-5 are diagram of an electronic, handheld banking device according to various embodiments of the present invention;

FIG. 6 is a diagram of an example home screen display for the handheld banking device according to various embodiments of the present invention;

FIG. 7 is a diagram of an example check displayable by the handheld banking device according to various embodiments of the present invention;

FIG. 8 is a diagram of an example account ledger displayable by the handheld banking device according to various embodiments of the present invention; and

FIG. 9 is a diagram of the handheld banking device in communication with a remote bank server system according to various embodiments of the present invention.

### DESCRIPTION

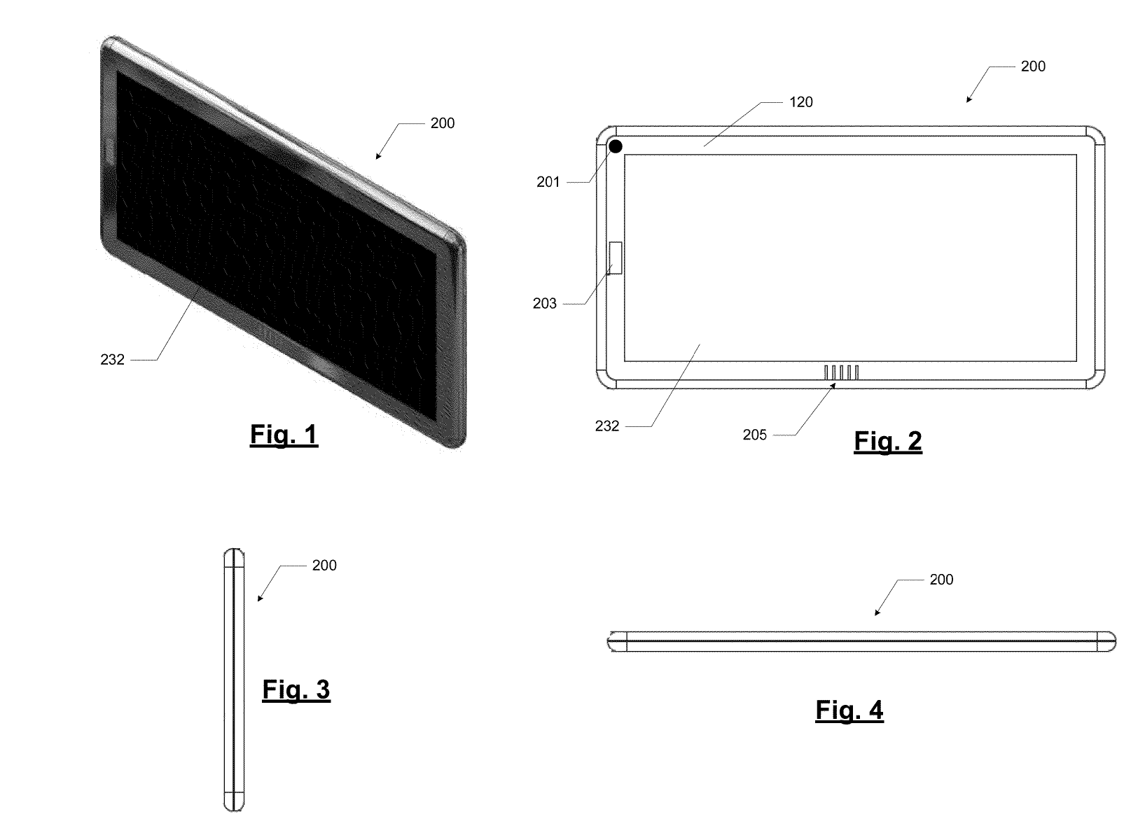

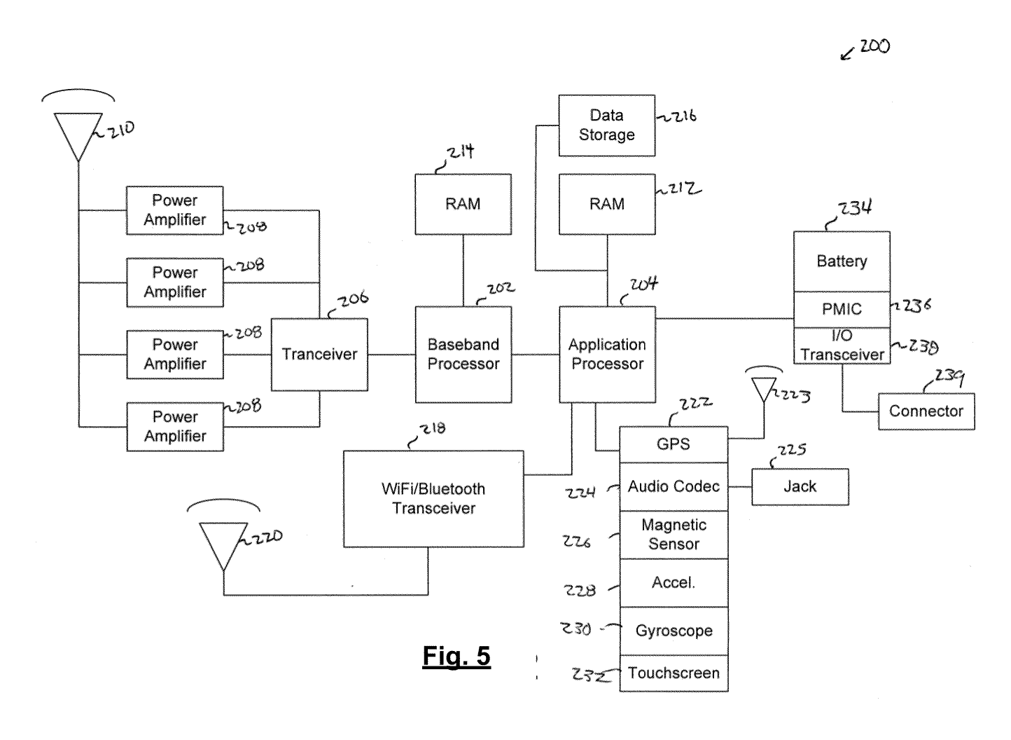

FIGS. 1-5 illustrate a handheld electronic banking device 200 according to various embodiments of the present invention. FIG. 1 is a perspective view; FIG. 2 is a front view; FIG. 3 is a top view; FIG. 4 is side view; and FIG. 5 is an internal block diagram. As described herein, a user of the device 200 may use the device 200 as a electronic checkbook. From the device 200, the user can write electronic checks (e-checks) much like a conventional paper check, review current account balances and checking ledger information, and otherwise manage their checking account.

Preferably the device 200 is sized to fit within a person's hand (handheld). Exemplary dimensions for the device 200 are: 6.75 inches long; 3.5 inches tall; and a depth of 0.25 inches. As shown in FIGS. 1-5, the device 200 includes frame 120 (preferably metallic) around a display 232. The display 232 is preferably a touch screen display that user can control through simple or multi-touch gestures by touching the screen 232 with one or more fingers, or a stylus, for example. The user can use the touch screen 232 to react to what is displayed and to control how it is displayed. The touch screen 232 preferably enables the user to interact directly with what is displayed, rather than using a mouse, touchpad, or any other intermediate device (other than a stylus). The touch screen 232 may be a resistive touch screen, a capacitive sensing touch screen, or any other suitable touch screen technology type. The dimensions of the touch screen 232 may be 6.00 inches by 2.75 inches according to various embodiments. The device 200 may also include a power on/off switch 201 in a corner as shown in FIGS. 1 and 2, although in other embodiments the power on/off switch 201 could be located at a different location. The device 200 may also include one or more LED lights 203 to indicate various device functions or indicators. In addition, the device 200 may include an acoustic speaker 205.

As shown in FIG. 5, the device 200 may comprise multiple processors 202, 204. A baseband processor 202 may handle communication over a mobile telecommunications network (e.g., cellular network) according to any suitable communications technology (e.g., 3G, 4G, etc.). As described further below, the mobile telecommunications network may be used to connect the device 200 to the remote servers of the user's bank via the Internet. The baseband processor 202 may comprise dedicated random access memory (RAM) 214. In various embodiments, the baseband processor 202 may be in communication with a transceiver 206. The transceiver 206 may, subsequently, be in communications with one or more power amplifiers 208 and an antenna 210. Outgoing signals for the mobile telecommunications network may be processed at baseband by the baseband processor 202 and provided to the transceiver 206. The transceiver 206 and/or the baseband processor 206 may modulate the outgoing signal to a carrier frequency. One or more of the amplifiers 208 may amplify the outgoing signal, which may be subsequently transmitted via antenna 210. Incoming signals for the mobile telecommunications network may be received by the antenna 210, amplified by one or more of the amplifiers 208 and provided to the transceiver 206. Either the transceiver 206 or the baseband processor 202 may demodulate the incoming signal to baseband.

An applications processor 204 may execute an operating system as well as software applications, including the personal checking and banking-related software applications described herein. The applications processor 204 may be in communications with applications RAM 212, and non-volatile data storage 216. The applications processor 204 may additionally be in communication with other hardware devices such as a combination WI-FI/BLUETOOTH transceiver 218. The WI-FI/BLUETOOTH transceiver 218 may handle radio frequency (RF) communication with a LAN (e.g., according to the WI-FI standard, or any suitable standard) or direct RF communications between the device 200 and another wireless device (e.g., according to the BLUETOOTH standard or any suitable standard). In various embodiments, the device 200 may also comprise a global positioning system (GPS) 222 that is in communication with a satellite-based GPS system via a GPS antenna 223 for providing the application processor 204 information describing the geographic location of the device 200. The touch screen 232 may both provide output to the user of the device 204 in visual form and receive input from the user. The input may be in the form of signals representing screen-touches by the user. An audio codec module 224 may provide hardware and/or software for decoding and playing audio signals. In some embodiments, the codec 224 may also comprise a digital-to-analog converter. Audio output signals may be provided to a jack 225, which may receive a set of headphones and/or speakers for playing the audio output signal.

Various other sensors may be included in certain embodiments. A magnetic sensor 226 may sense magnetic fields near the device. For example, the magnetic sensor 226 may be used by various apps and/or system functionality to implement a compass. An accelerometer 228 and gyroscope 230 may provide data describing movement of the device. For example, data from the accelerometer 228 and gyroscope 230 may be used to orient the display of the touch screen 232 (e.g., portrait versus landscape). The device 200 may be powered by a battery 234, which may, in turn, be managed by a power management integrated circuit (PMIC) 236. An I/O transceiver 238 may manage wired communications between the device and other devices, for example, according to the Universal Serial Bus (USB) or any other suitable standard. A connector 239 may facilitate wired connections. In some embodiments, connections via the connector 239 and I/O transceiver 238 may provide power for charging the battery 234.

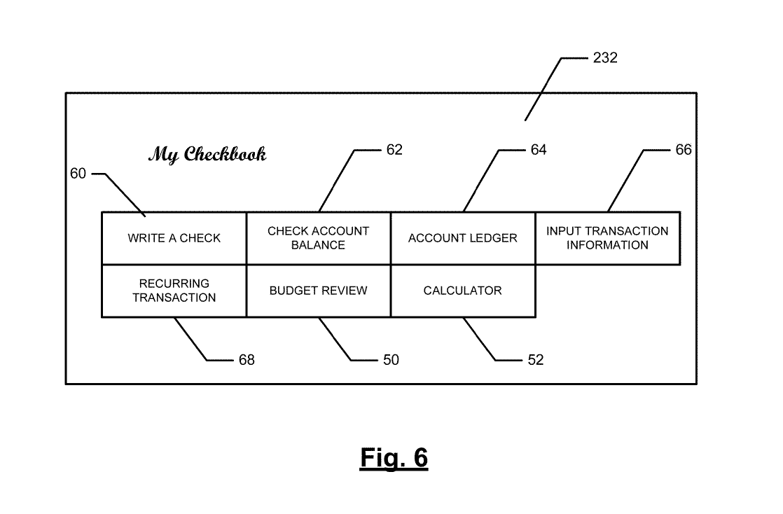

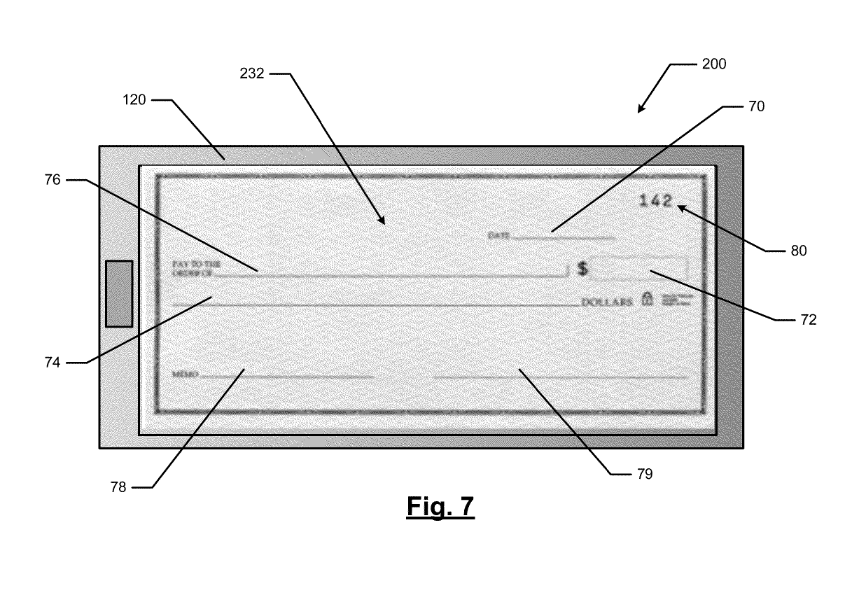

FIG. 6 shows an example home screen for the device 200. As shown in the example of FIG. 6, the touch screen display 232 may include an icon 60 that launches the check writing feature of the device. When the user clicks on or otherwise selects the icon 60 to write a check, a full-screen display of check for the user's account may appear, as shown in the example of FIG. 7, from which the user can write an e-check. The displayed check may allow the user to enter information to write an e-check. For example, when the user clicks on the date field 70, a date selection menu and/or touch screen keyboard may appear on the screen 232 to allow the user to enter the date of the check. Similarly, the user could enter the dollar amount of the check in numbers in the number amount field 72. When the dollar amount is entered, the device (executing, e.g., the software in the application RAM 212) may populate the word amount field 74 for the dollar amount in words. Also, the user could click on the payee field 76 to enter the payee for the check. The user could also enter information in the memo field 78. In various embodiments the user could enter an electronic signature at the signature field 79. Entering the signature and/or otherwise completing all of the necessary information for the check may cause a “send” inquiry to be displayed for the user, asking the user if he/she want to send the e-check, which would be akin to writing out a conventional paper check.

Each check may also include a check number 80 (in this example, “142”). The non-volatile memory 216 may store locally (at the device 200) information about the user's checking account so that the user can access the information in instances where there is no real-time communication link with the user's bank. The device memory 212, 216 may keep track of checks written from the user's checking account to maintain an up-to-date account balance. For example, assuming the current account balance is $100.00 and the user writes check #142 for $20.00, the device 200 (the application processor 204 executing software stored in the RAM 212 or non-volatile memory 216) may update the user's account to $80.00.

In addition, the device memory 212, 216 may store data about previously written checks so that data about the previously written checks could be selected from a drop-down window, for example, when writing a new check. For example, if the user previously wrote an e-check to ABC Co., and the user wanted to write another check to ABC Co., the user could tap or click on the payee field 76, which may cause the names of previous payees to display in a drop-down window associated with the payee field 76. The user could then select one of the previous payees, such as ABC Co. in this example, for the new check. Similarly, the device may provide an auto-complete feature, such that if the user types in the first few characters, one or more options for completing the field may be provided to the user for selection based on those typed-in initial characters. For example, if the user types in AB, an option to select ABC Corp as the payee may be provided to the user.

In various embodiments, the user may send a completed e-check from the device 200 in a number of ways. For example, the user could send the e-check to the payee via a local data communications network, e.g., a Bluetooth or direct Wi-Fi connection, via the Wi-Fi/Bluetooth transceiver 218 (see FIG. 5). This mode could be used, for example, at a point-of-sale (POS) location that has e-check capability and a wireless connection to receive the check data from the device 200 via the local data communications network. That is, instead of handing the sale clerk a blank check for e-check processing at a POS, the device 200 wireless transmits the e-check information (e.g., date, check amount, payee, check number, account owner information) to the POS e-check system for processing of the e-check. This mode of processing avoids the need for an Internet connection as the e-check data only needs to be sent from the device 200 to the POS e-check system. This mode does require, however, that the POS e-check system have a wireless transceiver for communicating wirelessly with the device 200.

Preferably the bank data sent from the device 200 is encrypted and capable of being decrypted by the POS e-check system. Also, as shown in FIG. 7, the display of the e-check when the user inputs data via the touch screen interface to issue the new check from the user's personal bank checking account does not display in various embodiments the bank routing number or user checking account number, which are ordinarily displayed on paper checks. Instead, the bank routing number and user checking account number may be stored in the non-volatile memory 216. With sending an e-check, the may also be sent with the check data, preferably encrypted. Storing the bank routing number and user checking account number in the non-volatile memory 216, and not displaying them on the screen 232 of the device 200, should reduce theft. Also, the bank routing number and user checking account number stored in the non-volatile memory 216 is preferably password protected to further prevent theft and fraud.

In another mode, the check data may be transmitted to the payee via the mobile telecommunications network (e.g., using the transceiver 206). In this mode, the check data may be transmitted, for example, via the Internet using the mobile telecommunications network to the payee. As before, the transmitted check data may include the date, the check amount, the payee, the check number, the account owner information, the routing number and the account number, preferably encrypted. This mode is preferably used when the payee is not physically close to the user's device 200.

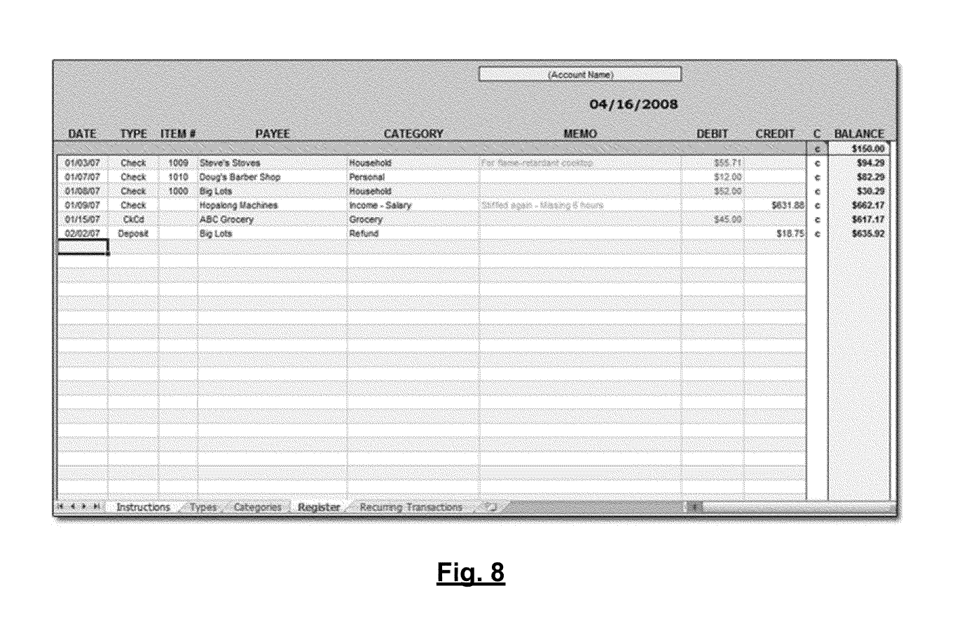

In either mode, the device memory 212, 216 may track the check data for e-checks written from the device 200 in order to maintain a current account balance locally at the device. In addition, the device may also store other account data, such as deposits, fees, withdrawals, interest, etc. in order to maintain an accurate ledger for the user's checking account. The user can opt to view the account balance through a selection provided by the touch screen 232, such as the “Check Account Balance” icon 62 in FIG. 6. Similarly, the user may opt to view the account ledger, or recent activity for the account, by selecting the “Account Activity” icon 64 in FIG. 6. An example ledger is shown in FIG. 8. Similar to a conventional paper ledger, the device ledger display may include a series of column and rows. The series of columns may include columns for: date of transaction; type of transaction (e.g., check or deposit); item number (e.g., check number); payee; amount (e.g., debit or credit as the case may be); current balance; etc. The rows may be used to record and show the data for the account transactions, e.g., checks deposits, withdrawals, etc. The user could be page forward or backward to see more recent or past activity respectively, for example.

In various embodiments, the device 200 may keep track of withdrawals of the checking account based on the checks that are written on the checking account as described above by tracking the data sent to the payee. For other types of transactions, such as withdrawals, deposits, interest, fees, etc., whether made online, through an automatic teller machine (ATM), with a debit card, or at the bank itself, the device 200 may track (and store in memory) the data in one or more ways. For example, the user could input the data for such other types of transactions via the touch screen interface 232. For example, when the user makes a deposit in the checking account, the user could select an option on the touch screen interface 232, such as the “Input Transaction Information” icon 66 in the example of FIG. 6, to input data about the deposit, such as the amount and the date. Similarly, for withdrawals, interest, fees, etc., the user could select an option on the interface to input data about the transaction, including the amount and the date.

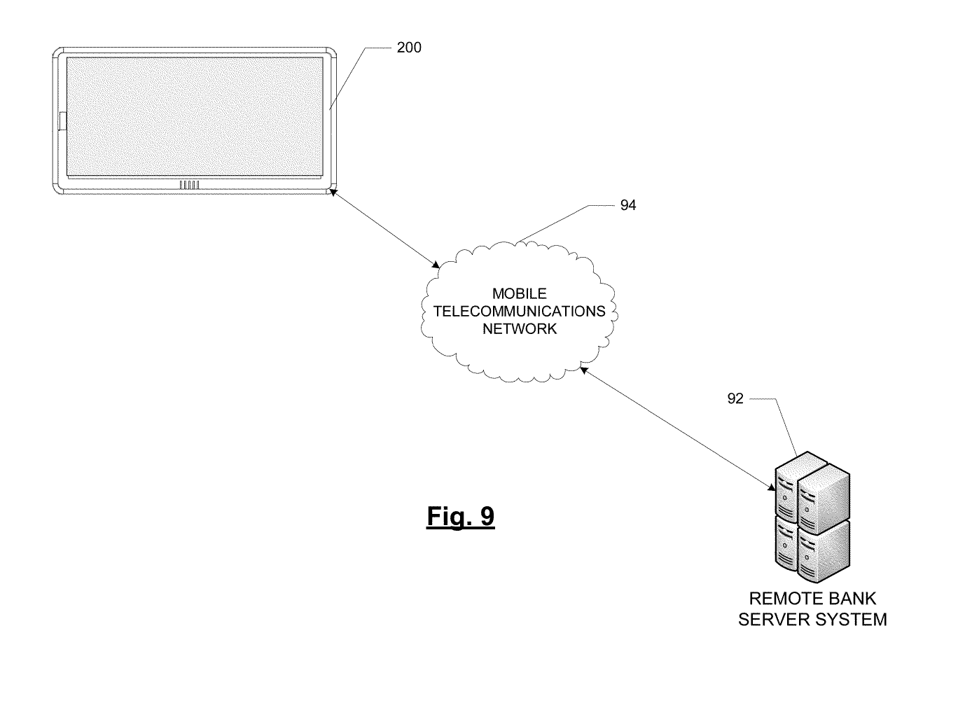

In addition, as shown in FIG. 9, the device 200 may periodically synchronize its data with the data of the bank at the remote bank servers 92 via the mobile telecommunications network 94. The remote bank servers 92 may store data pertaining to the user's checking account, including account owner information and transaction data (e.g., types of transactions, amounts, dates, etc.). In such an embodiment, the device 200 may periodically of from time-to-time reconcile its data with the remote bank server system 92. For example, every time period, the remote bank servers 92 may transmit data about transactions on the account since the last time period. The device 200 can then update its internally stored data to reflect the most up-to-date ledger information (e.g., transactions and balances). That way, when the user selects the option to view the ledger information, the user gets the most up-date-information. The time periods when such account information is exchanged and the account information updated could be any suitable period of time, such as every N days or every N hours (N>1), or some other suitable time period. This process however would require a connection between the device 200 and remote bank server system 92 via the mobile telecommunications network 94. If the device 200 was not able to connect to the mobile telecommunications network 94 for some reason, the ledger data stored on the device 200 would only be as up-to-date as the last account data synchronization.

Returning to FIG. 6, the device 200 may also allow the user to input data for recurring transactions via, for example, a “Recurring Transaction” icon 68. The recurring transactions may be recurring payments or deposits from or to the account, for example. For recurring payments, the relevant data to be entered and stored by the device 200 might include the periodicity (e.g., monthly, weekly, etc.), the payee, and the amount. When the time for a recurring payment is reached, the device 200 may automatically generate and transmit an e-check as described above based on the recurring transaction data stored in the device 200.

The device 200 may also provide a budget review feature, where the device could store in its memory data for a personal budget for the user. Upon selection of the “Budget Review” icon 50 in the example home screen display in FIG. 6, information about the user's budget may be displayed on the touch screen 232 so that the user can review and assess the budget and adherence thereto. In that connection, the device 200 may be programmed to calculate expenses so that wasteful spending could be more easily identified. For example, expenses from the checking account could be categorized by the user in, for example, various user-defined categories (e.g., entertainment, groceries, car maintenance, clothing, education, childcare, insurance, etc.) and compared to the budget to determine adherence to the budget and identify wasteful spending. Also, the device 200 could be programmed to compute and display percentage of funds spent on the various categories. The device 200 may also include a calculator function, which may be accessed by activating the calculator icon 52 in the example home screen of FIG. 6.

Of course, in other embodiments, different icons and/or different icon designs may be used that would allow the user to select the various checking account-related functions of the device. Also, other features could be included. For example, in another embodiment the home screen could include an icon that allows the user to check the user's investment portfolio. For example, the home screen may also include a “Portfolio” or other similar icon that suggest to the user that when the icon is selected, the user's investment portfolio is checked. In various embodiments, the user may pre-configure the device with information about the investment company where the user has an investment account and the user's log-in credentials (e.g., URL for account, account number, userID, passcode, etc.) This information may be stored in the device memory. When the user selects the “Portfolio” button, the device may connect to the user's account web page via the Internet, using the user's login credentials stored in the device. That way, the user can additionally review his/her investment portfolio using the device 200.

In various embodiments, the device 200 may be a stand-alone device; that is, a device that only provides checking account-related functions. In such embodiments, the device 200 would not provide other functions, such as phone, calendar, internet browsing, gaming, etc. In other embodiments, the device 200 could be a multi-function device, such as a smartphone. In such embodiments, the checking-account related functions described herein may be accessed by opening and running an application (or “app”) for the checking account that is downloaded and stored to the device/smartphone 200. For example, when the user runs the app, a checking account home screen, such as the example in FIG. 6, may be displayed for the user that allows the user to perform the various banking-related functions. In both embodiments, access to the banking-related functions is password-protected. For example, for the stand-alone banking device, the user may need to enter authenticating information to launch the banking-related functions, such as a password. In a smartphone app embodiment, for example, upon opening the app may request authenticating information before launching the banking-related functions.

Thus, various embodiments of the present invention can provide numerous advantages and conveniences to a person (or user) with a checking account. The advantages and conveniences include, for example: (1) easier and faster manageability of accounts; (2) no paper or writing utensils needed; (3) extensive solid state memory storage with checks appearing as written; (4) up-to-date account balance information at the user's fingertips, including up-to-date e-check, debit card, online and ATM transactions; (5) touch screen interface; (6) internet capabilities (through the mobile telecommunications network, for example); (7) automatic recurring transactions and automatic bill pay feature; (8) auto complete entry, such as for the payee field on the checks; (9) budget review, including calculated expenses to identify wasteful spending; (10) compute and display the percentage of funds spent on various expense categories; and (11) memo field for checks.

According to various embodiments, therefore, the present invention is directed to a programmed mobile computing device for personal banking for a user. The programmed mobile computing device comprises: a touch screen interface; at least one memory unit that stores data; at least one processor; a mobile telecommunications transceiver; and a local network transceiver. The data that the at least one memory unit stores comprises user bank account data that comprises, for a personal checking account of the user at a bank: (i) a routing number for the bank associated with the user's personal bank checking account; (ii) an account number for the user's personal bank checking account; (iii) check data that comprises, for each check written from the personal bank checking account over the time period, (a) a check dollar amount, (b) a date, and (c) a payee; and (iv) deposit data that comprises, for each deposit to the personal bank checking account over the time period, (a) a deposit dollar amount, and (b) a date. The mobile telecommunications transceiver is in communication with the at least one processor and is for sending and receiving wireless communications via a mobile telecommunications network. The local network transceiver in communication with the at least one processor and is for sending and receiving wireless communications via a local data network. The at least one processor is in communication with the at least one memory and the touch screen interface. It is programmed to: (i) display on the touch screen interface upon a request from the user a current account balance for the personal bank checking account of the user, wherein the current account dollar balance for the personal bank checking account is determined by the at least one processor based on transaction data stored in the at least one memory, wherein the transaction data comprises check data and the deposit data for the personal banking account; (ii) transmit, via the local data network, data for a new check written by the user from the personal bank checking account at a point-of-sale location upon initiation of a point-of-sale check request by the user via the touch screen interface, wherein the transmitted data for the new check comprises (a) the routing number for the for the bank associated with the user's personal bank checking account, (b) the account number for the user's personal bank checking account, and (c) the check dollar amount, and wherein the routing number and the account number are not displayed on the touch screen interface when the user inputs data via the touch screen interface to issue the new check from the user's personal bank checking account; and (iii) update activity for the checking account with transaction data received from a remote bank computer server system via the mobile telecommunications network, wherein the remote bank computer server system stores account data of the bank for the personal bank checking account of the user, including the transaction data for the personal banking account, to update the check and deposit data stored in the at least one memory of the device with the account data for the personal bank checking account of the user stored at the remote bank computer server system.

In various implementations, the processor is further programmed to transmit, via the mobile telecommunications network, the data for the new check written by the user from the personal bank checking account upon initiation of a remote check request by the user via the touch screen interface. Additionally, the processor may be further programmed to display on the touch screen interface upon a request from the user account activity data for the personal bank checking account of the user, wherein the account activity data for the personal bank checking account is determined by the at least one processor based on transaction data stored in the at least one memory.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, methods or processing structures described herein are necessarily intended to limit the scope of the invention.

The described features can be implemented advantageously in one or more computer programs that are executable on a programmable system as describe above, including at least one programmable processor coupled to receive data and instructions from, and to transmit data and instructions to, a data storage system, at least one input device, and at least one output device. A computer program is a set of instructions that can be used, directly or indirectly, in a processor-based computer device to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment. Suitable processors for the execution of a program of instructions include, by way of example, both general and special purpose microprocessors, and the sole processor or one of multiple processor or cores, of any kind of computer. Generally, a processor will receive instructions and data from a read-only memory or a random access memory or both. Storage devices suitable for tangibly embodying computer program instructions and data include all forms of non-volatile memory, including by way of example semiconductor memory devices, such as EPROM, EEPROM, and flash memory devices.

Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices. It should be borne in mind, however, that all of these and similar terms are to be associated with the appropriate physical quantities and are merely convenient labels applied to these quantities.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused descriptions would not facilitate a better understanding of the present invention, and therefore, a more detailed description of such elements is not provided herein.

Moreover, the processes associated with the present embodiments may be executed by programmable equipment, such as computers. Software or other sets of instructions may be employed to cause programmable equipment to execute the processes. The processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

1. A programmed mobile computing device for personal banking for a user, the programmed mobile computing device comprising:
a touch screen interface;
at least one memory unit that stores data, the data comprising user bank account data, wherein the user bank account data comprises, for a personal checking account of the user at a bank:
a routing number for the bank associated with the user's personal bank checking account;
an account number for the user's personal bank checking account;
check data that comprises, for each check written from the personal bank checking account over the time period, (i) a check dollar amount, (ii) a date, and (iii) a payee; and
deposit data that comprises, for each deposit to the personal bank checking account over the time period, (i) a deposit dollar amount, and (ii) a date;
at least one processor in communication with the at least one memory and the touch screen interface;
a mobile telecommunications transceiver in communication with the at least one processor, wherein the mobile telecommunications transceiver is for sending and receiving wireless communications via a mobile telecommunications network; and
a local network transceiver in communication with the at least one processor, wherein the local telecommunications transceiver is for sending and receiving wireless communications via a local data network, and
wherein the at least one processor is programmed to:
display on the touch screen interface upon a request from the user a current account dollar balance for the personal bank checking account of the user, wherein the current account dollar balance for the personal bank checking account is determined by the at least one processor based on transaction data stored in the at least one memory, wherein the transaction data comprises check data and the deposit data for the personal banking account;
transmit, via the local data network, data for a new check written by the user from the personal bank checking account at a point-of-sale location upon initiation of a point-of-sale check request by the user via the touch screen interface, wherein the transmitted data for the new check comprises (i) the routing number for the for the bank associated with the user's personal bank checking account, (ii) the account number for the user's personal bank checking account, and (iii) the check dollar amount, and wherein the routing number and the account number are not displayed on the touch screen interface when the user inputs data via the touch screen interface to issue the new check from the user's personal bank checking account; and
update activity for the checking account with transaction data received from a remote bank computer server system via the mobile telecommunications network, wherein the remote bank computer server system stores account data of the bank for the personal bank checking account of the user, including the transaction data for the personal banking account, to update the check and deposit data stored in the at least one memory of the device with the account data for the personal bank checking account of the user stored at the remote bank computer server system.

2. The device of claim 1, wherein the processor is further programmed to transmit, via the mobile telecommunications network, the data for the new check written by the user from the personal bank checking account upon initiation of a remote check request by the user via the touch screen interface.

3. The device of claim 1, wherein the processor is further programmed to display on the touch screen interface upon a request from the user account activity data for the personal bank checking account of the user, wherein the account activity data for the personal bank checking account is determined by the at least one processor based on transaction data stored in the at least one memory.
